(19) United States
(12) Patent Application Publication
(10) Pub. No.: US 2009/0057059 A1
(43) Pub. Date: Mar. 5, 2009

(54) Bearing lubricating device

(76) Inventor: Pi-Liang Wu, Taichung (TW)

Correspondence Address: PI-LIANG WU, P.O.BOX 55-124, TAICHUNG, TW

(21) Appl. No.: 11/976,471

(22) Filed: Oct. 25, 2007

(30) Foreign Application Priority Data
Aug. 31, 2007 (TW) 096214562

(51) Int. Cl. F16N 11/02

(52) U.S. Cl. 184/5.1; 184/28

(57) ABSTRACT

A bearing lubricating device includes a container and a piston member is located in the container and movably in contact with an inner periphery of the container. The piston member includes a concaved top surface and a concaved underside. A center post is located at a center of the piston member and a central passage is defined axially through the center post and through the concaved underside. A plurality of passages are defined through the concaved underside and located around the center post. A grease fitting has a cone-shaped portion on a lower end thereof and a handle is located on a top end of the grease fitting. A recess is defined in the lower end of the grease fitting and the center post is securely engaged with the recess.

### FIELD OF THE INVENTION

The present invention relates to a bearing lubricating device with piston member which has a concaved underside so as to guide the lubricant to lubricate the bearing without too much resistance.

### BACKGROUND OF THE INVENTION

A conventional bearing lubricating device is disclosed in U.S. Pat. No. 6,520,292 and FIG. 1 shows the device which generally includes a container 1 with a piston member 2 slidably received therein and the piston member 2 includes a concaved top surface 202 and a flat underside. A plurality of passages 203 are defined through the underside of the piston member 2 and communicate with the concaved top surface 202. A center post 201 extends from a center of the concaved top surface 202 and a central passage is defined through the center post 201. An inlet member 204 is connected on a top of the center post 201 and communicates with the central passage. A spring 205 is connected to a lower end of the center post 201. A grease fitting 3 includes a recess 303 and the center post 201 is threadedly engaged with the recess 303. The grease fitting 3 further includes a cone-shaped portion 301 on a lower end thereof such that the bearing to be lubricated is positioned between the cone-shaped portion 301 and the concaved top surface 202. A handle 302 is connected on a top end of the grease fitting 3 for convenience of operation. A cap 4 is mounted to the top of the container 1 to avoid dust from entering the container 1. A space between the flat underside of the piston member 2 and the container 1 is filled with lubricant which is filled in the space via the inlet member 204 and the central passage in the center post 201. When pushing the grease fitting together with the piston member 2 downward, the lubricant in the space pass through the passages 203 to lubricate the bearing between the cone-shaped portion 301 and the concaved top surface 202. However, it is experienced that when the flat underside of the piston member 2 is lowered to compress the lubricant, a significant resistance is occurred so that the user has to apply a larger force to push the grease fitting 3 to lubricate the bearing.

The present invention intends to provide a bearing lubricating device wherein the piston member has a concaved underside which efficiently guides the lubricant to pass through the passages to lubricate the bearing.

### SUMMARY OF THE INVENTION

The present invention relates to a bearing lubricating device that comprises a container having a bottom wall with a cylindrical sidewall extending from the bottom wall and a piston member is located in the container and movably in contact with an inner periphery of the cylindrical sidewall. A concaved top surface is defined in a top of the piston member so that a bearing to be lubricated is rested on the concaved top surface. A concaved underside is defined in an underside of the piston member. A center post is located at a center of the piston member and a central passage is defined axially through the center post and through the concaved underside. A plurality of passages are defined through the concaved underside and located around the center post. A grease fitting has a cone-shaped portion on a lower end thereof so as to position the bearing to be lubricated between the concaved top surface and the cone-shaped portion. A handle is located on a top end of the grease fitting and a recess is defined in the lower end of the grease fitting. The center post is securely engaged with the recess. When pushing the handle together with the piston member downward, the lubricant in a space between the bottom wall of the container and the concaved underside of the piston member is forced to pass through the passages to lubricate the bearing. The lubricant is guide by the concaved underside such that the resistance to the piston member is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional bearing lubricating device;

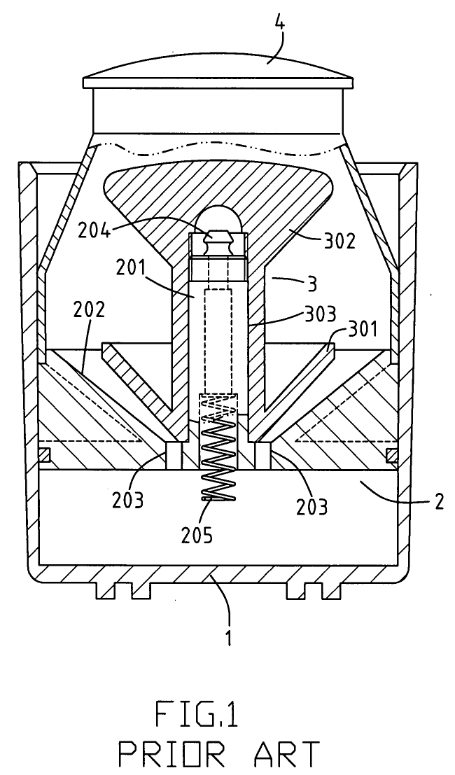

FIG. 2 is a perspective view to show the bearing lubricating device of the present invention;

FIG. 3 is an exploded view to show the bearing lubricating device of the present invention;

FIG. 4 is a cross sectional view to show the bearing lubricating device of the present invention, and

FIG. 5 is a cross sectional view to show another embodiment of the piston member of the bearing lubricating device of the present invention.

### DETAILED DESCRIPTION OF THE PREFERRED EMBODIMENT

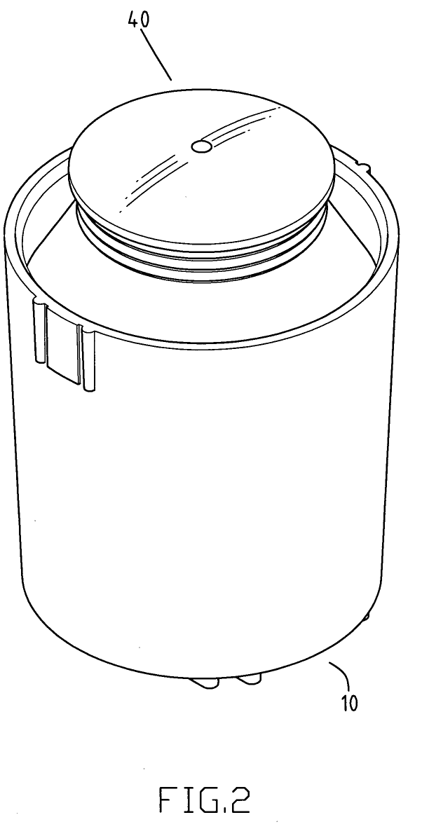

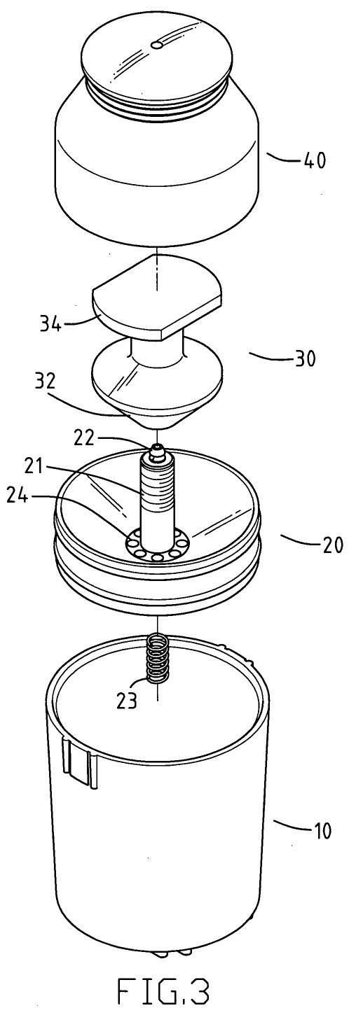

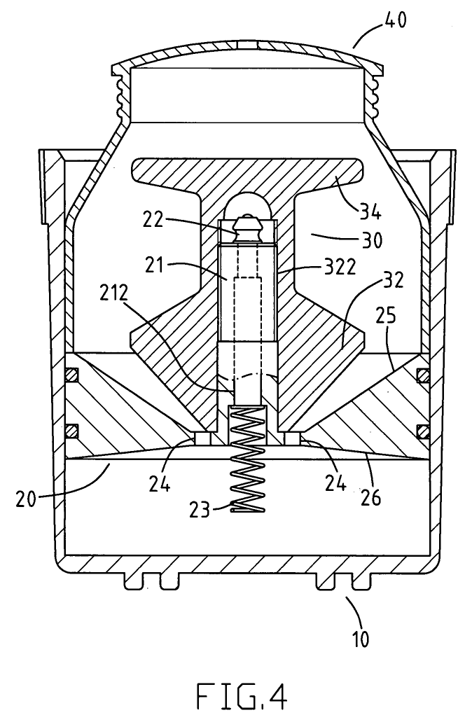

Referring to FIGS. 2 to 4, the bearing lubricating device of the present invention comprises a container 10 having a bottom wall with a cylindrical sidewall extending from the bottom wall and the inner diameter of the cylindrical sidewall is constant.

A piston member 20 is located in the container 10 and a periphery of the piston member 20 is cooperated with two seal rings which are movably in contact with an inner periphery of the cylindrical sidewall of the container 10. A concaved top surface 25 is defined in a top of the piston member 20 and a concaved underside 26 is defined in an underside of the piston member 20. The concaved underside 26 is a cone-shaped surface. A center post 21 is located at a center of the piston member 20 and a central passage 212 is defined axially through the center post 21 and through the concaved underside 26. A plurality of passages 24 are defined through the concaved underside 26 and located around the center post 21. An member 22 is connected to a top end of the center post 21 and communicates with the central passage 212.

A grease fitting 30 has a cone-shaped portion 301 on a lower end thereof and a handle 34 is located on a top end of the grease fitting 30. A recess 322 is defined in the lower end of the grease fitting 30 and the center post 21 is securely engaged with the recess 322. A spring 23 which has one end engaged with the central passage 212 of the center post 21.

Lubricant is filled in a space between the bottom wall of the container 10 and the concaved underside 26 of the piston member 20 via the inlet member 22 and the central passage 212.

When lubricating the bearing (not shown) which is positioned between the concaved top surface 25 of the piston member 20 and the cone-shaped portion 32 of the grease fitting 30, the user pushes the handle 34 downward to force the lubricant in the space to pass through the passages 24 to lubricate the bearing. It is noted that because of the concaved underside 26, the lubricant is guided smoothly and pass through the passages 24 efficiently. In other words, the user does not need to apply too much force to the handle 34.

A cap 40 is mounted to the open top of the container 10 to prevent dust from entering the container 10.

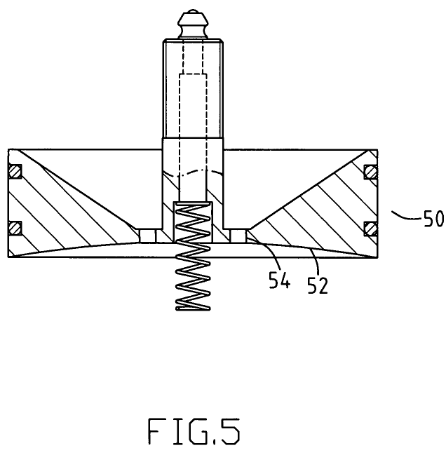

As shown in FIG. 5, the concaved underside 52 of the piston member 50 can be a concaved curved surface which also achieves the same function as the cone-shaped concaved underside 26.

While we have shown and described the embodiment in accordance with the present invention, it should be clear to those skilled in the art that further embodiments may be made without departing from the scope of the present invention.

What is claimed is:

1. A bearing lubricating device comprising:
a container having a bottom wall with a cylindrical sidewall extending from the bottom wall;
a piston member located in the container and movably in contact with an inner periphery of the cylindrical sidewall, a concaved top surface defined in a top of the piston member and a concaved underside defined in an underside of the piston member, a center post located at a center of the piston member and a central passage defined axially through the center post and through the concaved underside, a plurality of passages defined through the concaved underside and located around the center post, and
a grease fitting having a cone-shaped portion on a lower end thereof and a handle located on a top end of the grease fitting, a recess defined in the lower end of the grease fitting and the center post being securely engaged with the recess.

2. The device as claimed in claim 1, wherein the concaved underside is a cone-shaped surface.

3. The device as claimed in claim 1, wherein the concaved underside is a concaved curved surface.

4. The device as claimed in claim 1, wherein an inlet member is connected to a top end of the center post and communicates with the central passage.

5. The device as claimed in claim 1 further comprising a spring which has one end engaged with the central passage of the center post.

6. The device as claimed in claim 1, wherein a cap is mounted to an open top of the container.
